(19) United States
(12) Patent Application Publication
(10) Pub. No.: US 2019/0390396 A1
(43) Pub. Date: Dec. 26, 2019

(54) ROBOT AND CLOTHES FOLDING APPARATUS INCLUDING THE SAME

(71) Applicant: LG ELECTRONICS INC., Seoul (KR)

(72) Inventor: Hoseong KWAK, Seoul (KR)

(73) Assignee: LG ELECTRONICS INC., Seoul (KR)

(21) Appl. No.: 16/563,562

(22) Filed: Sep. 6, 2019

(30) Foreign Application Priority Data
Jul. 15, 2019 (KR) 10-2019-0084897

(51) Int. Cl. D06F 89/00; B25J 11/00

(52) U.S. Cl. CPC D06F 89/00; B25J 11/008

(57) ABSTRACT

A robot is provided. While repeating the process of jigging and lifting the lowest part of the clothes by the first robot arm and the first gripper and jigging and lifting the lowest part of the clothes by the second robot arm and the second griper, the image sensor senses the shape of the clothes jigged by the first and second grippers to rapidly and exactly provide clothes spread in wrinkles one by one.

### CROSS-REFERENCE TO RELATED APPLICATIONS

This application is based on and claims priority under 35 U.S.C. § 119 and 35 U.S.C. § 365 to Korean Patent Application No. 10-2019-0084897, filed on Jul. 15, 2019, in the Korean Intellectual Property Office, the disclosure of which is incorporated by reference herein its entirety.

### BACKGROUND

The present disclosure relates to a robot capable of lifting one of a plurality of pieces of clothes in the air, and rapidly and exactly spreading wrinkles of the clothes, and fully automating a series of processes of spreading or folding the clothes, and a clothes folding apparatus including the same.

In general, clothes may be made of a soft textile material and may be folded to be stored or moved.

A person may fold the clothes, but may use a clothes folding device which is a device to fold clothes.

Clothes subject to washing, drying, or dust removing are mixed with each other while being tangled with each other before put into the clothes folding device. Accordingly, after the person personally spreads only one of the plurality of pieces of clothes, the person can put the clothes into the clothes folding apparatus.

FIGS. 1A and 1B are views illustrating a clothes folding device.

As illustrated in FIGS. 1A and 1B, when clothes A is clamped by a clothespin provided at an upper portion of a front surface of a clothes folding device 1 and then an operating button is pressed, the clothes A is introduced into the clothes folding device 1, and the clothes A is automatically folded.

After the clothes A is folded, the clothes A neatly folded may be discharged through an outlet provided in a lower portion of the front surface of the clothes folding device 1.

However, since the clothes A subject to washing or drying are discharged while being tangled and wrinkled, a user has to personally pick up one of wrinkled clothes, spread the wrinkles, and feed the spread clothes into the clothes folding device. In addition, it is difficult to fully automating a series of process of spreading and folding clothes tangled or wrinkled one by one.

### SUMMARY

The present disclosure is to provide a robot capable of lifting one of a plurality of pieces of clothes in the air and rapidly and exactly spreading wrinkles of the clothes, and fully automating a series of processes of spreading or folding the clothes, and a clothes folding apparatus including the same.

According to an embodiment of the present disclosure, a robot may include a first guide bar and a second guide bar separated from each other, a first robot arm and a second robot arm provided to be lifted or rotated along the first and second guide bars and having end portions to move with a predetermined degree of freedom, a first gripper and a second gripper provided end portions of the first and second robot arms to jig clothes, an image sensor to measure a shape of the clothes jigged by the first and second grippers, and a controller to control operations of the first and second robot arms and the first and second grippers depending on the shape of the cloths measured by the image sensor.

The first and second robot arms may be provided on opposite surfaces of the first and second guide bars.

The image sensor photographs the shape of the clothes when the first and second robot arms and the first and second grippers jig and lift the clothes.

The controller may determine an unfolding state of the clothes by comparing a lower image of the clothes, which is measured by the image sensor, with reference images which are previously input.

The controller may control a process of allowing the second robot arm and the second gripper to jig a second point of the clothes, which is lower than a first point of the clothes, and to lift the clothes, when the first robot arm and the first gripper jig the first point of the clothes and lift the clothes in the air, and allowing the first robot and the first gripper to jig a third point of the clothes, which is lower than the second point of the clothes, and to lift the third point of the clothes in the air.

The controller may set the lowest part of the clothes to the second point or the third point when lifting the clothes in the air.

The controller may repeatedly control the process until determining that the shape of the clothes measured by the image sensor is unfolded. Preferably, the controller may perform the process at least five times.

According to the present disclosure, a clothes unfolding unit may further include a third robot arm provided on one of the first and second guide bars to be lifted or rotated and having an end portion to move with a predetermined degree of freedom, and a third gripper provided at the end portion of the third robot arm to jig a hanger for hanging the clothes. The controller may control operations of the third robot arm and the third gripper depending on the shape of the clothes, which are measured by the image sensor.

The third robot arm may be provided under one of the first and second robot arms.

The third gripper may able to jig the hanger unfolded in one-touch type.

The controller may control the third robot arm and the third gripper to hang the clothes, which are jigged by the first and second grippers, on the hanger, when the shape of the clothes measured by the image sensor is determined as being spread.

The controller may control the third robot arm and the third gripper to move the hanger and clothes hung on the hanger to move a specific position out of the first and second guide bars.

According to the present disclosure, the clothes unfolding unit may further include a fourth robot arm provided on one of the first and second guide bars to be lifted or rotated and having an end portion to move with a predetermined degree of freedom, and a fourth gripper provided at the end portion of the fourth robot arm to jig a hanger jigged by the third gripper. The controller may control the forth robot arm and the fourth gripper to move the hanger and clothes hung on the hanger to move a specific position out of the first and second guide bars.

According to an embodiment, the clothes unfolding unit may include the robot, and a folding unit to receive spread clothes from the robot and to fold the clothes in a predetermined shape.

According to the robot of the present disclosure, while repeating the process of jigging and lifting the lowest part of the clothes by the first robot arm and the first gripper and jigging and lifting the lowest part of the clothes by the second robot arm and the second griper, the image sensor senses the shape of the clothes jigged by the first and second grippers to rapidly and exactly provide clothes spread in wrinkles one by one.

According to the clothes folding apparatus of the present disclosure, the robot picks up one of a plurality of pieces of clothes in the air, spreads the wrinkles of the clothes, and provides the spread clothes to the folding unit. The folding unit folds the spread clothes in a predetermined shape, thereby fully automating a series of processes of spreading and folding the clothes.

Accordingly, a process of spreading the clothes or a series of processes of spreading and folding clothes may be automated. The time and manpower required for the processes may be reduced, and the user convenience may be increased.

### BRIEF DESCRIPTION OF THE DRAWINGS

FIGS. 1A and 1B are views illustrating a clothes folding apparatus.

FIG. 2 illustrates an AI device according to an embodiment of the present disclosure.

FIG. 3 illustrates an AI server according to an embodiment of the present disclosure.

FIG. 4 illustrates an AI system according to an embodiment of the present disclosure.

FIGS. 5 to 7 are views illustrating a robot according to various embodiments of the present disclosure.

FIG. 8 is a block diagram illustrating the control flow of the robot according to the present disclosure.

FIGS. 9A to 9F are views illustrating a process that the robot spreads clothes according to the present disclosure.

FIG. 10 is a flowchart illustrating the operation of the robot according to the present disclosure.

### DETAILED DESCRIPTION OF THE EMBODIMENTS

Hereinafter, the present embodiment will be described in detail with reference to accompanying drawings.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers.

Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

FIG. 2 illustrates an AI device 100 including a robot according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 2, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

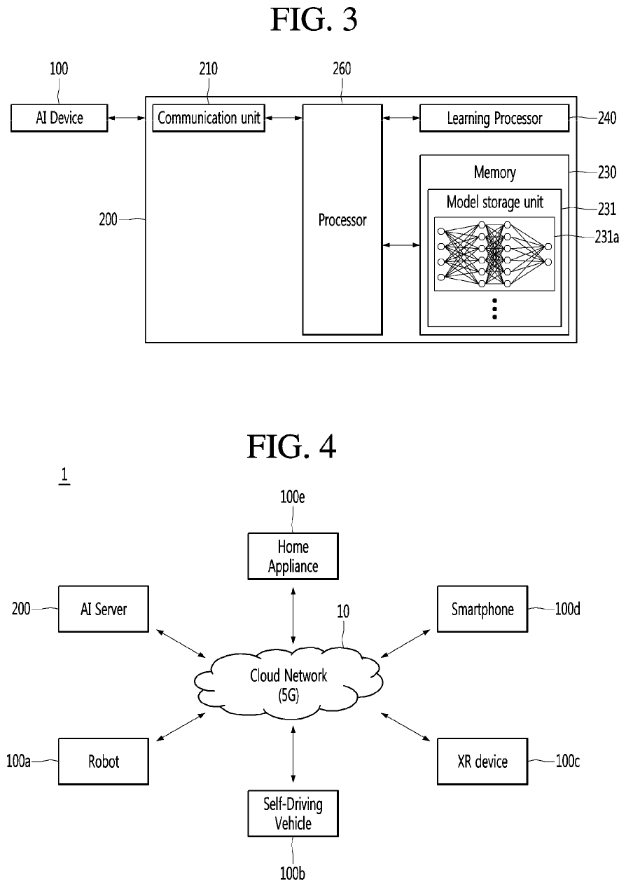

FIG. 3 illustrates an AI server 200 connected to a robot according to an embodiment of the present invention.

Referring to FIG. 3, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

FIG. 4 illustrates an AI system 1 according to an embodiment of the present invention.

Referring to FIG. 4, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 4 may be regarded as a specific embodiment of the AI device 100 illustrated in FIG. 2.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

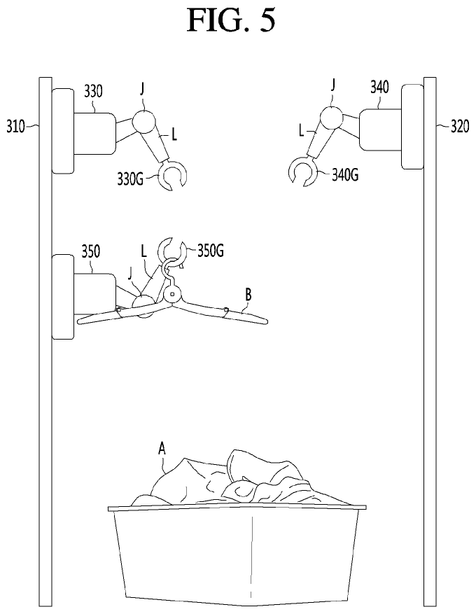

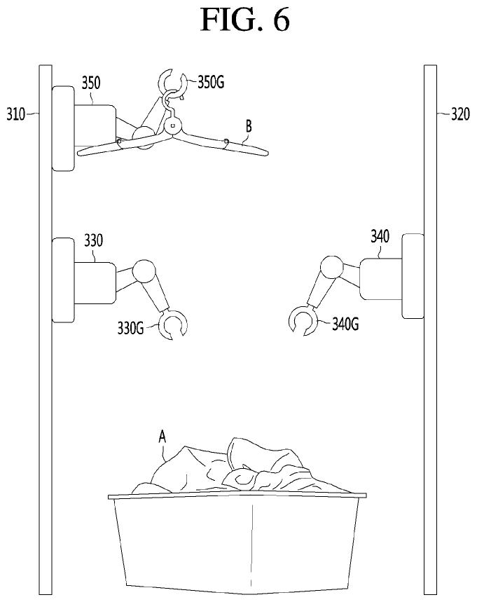

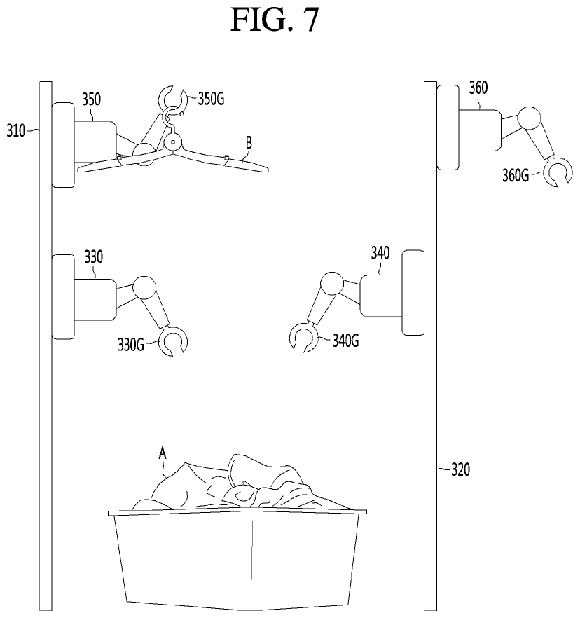

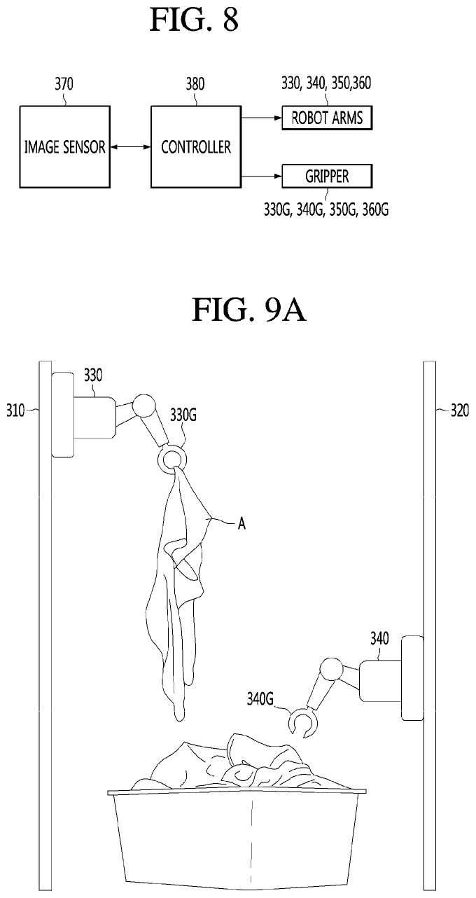

FIGS. 5 to 7 are views illustrating a robot according to various embodiments of the present disclosure, and FIG. 8 is a block diagram illustrating the control flow of the robot according to the present disclosure.

According to a first embodiment of the present disclosure, as illustrated in FIGS. 5 and 8, a robot 300 includes first and second guide bars 310 and 320, second and third robot arms 330, 340, and 350, first, second and third grippers 330G, 340G and 350G, an image sensor 370, and a controller 380.

The first and second guide bars 310 and 320 may have the shape of a bar or a plate extending in a vertical direction, and may face each other to be spaced apart from each other in a horizontal direction by a predetermined direction. In addition, a frame may be additionally provided to fix the first and second guide bars 310 and 320 or couple the first and second guide bars 310 and 320 to each other.

The first and second guide bars 310 and 320 may include elevation rails extending longitudinally in an up-down direction along opposite surfaces of the first and second guide bars 310 and 320, and additional driving units (not illustrated) are provided to lift the first, second, and third robot arms 330, 340, and 350 along the elevation rails of the first and second guide bars 310 and 320.

Although the first and second guide bars 310 and 320 may be provided in a fixing manner, the first and second guide bars 310 and 320 may be provided to be rotatable around an axis extending in a lengthwise direction of the first and second guide bars 310 and 320, but is not limited thereto.

The first, second, and third robot arms 330, 340, and 350 have the structures in which a plurality of links L are connected with each other by a plurality of joints J and may be provided on opposite surfaces of the first and second guide bars 310 and 320 to be lifted.

The first and second robot arms 330 and 340 may be provided on opposite surface of the first and second guide bars 310 and 320 and may move first and second grippers 330G and 340G to desired positions to grip clothes.

The third robot arm 350 may be provided under the first robot arm 330 on the first guide bar 310 or under the second robot arm 340 on the second guide bar 320 to move a third gripper 350G, which is able to grip the hanger B, to a desired position.

Although the third robot arm 350 is provided on the inner surface of the firs guide bar 310 or the second guide bar 320 to be lifted, the third robot arm 350 may be provided to be rotatable from the inner surface of the firs guide bar 310 or the second guide bar 320 to the outer surface of the first guide bar 310 or the second guide bar 320. In other words, an end portion of the third robot arm 350 may be moved to a specific position provided at outer portions of the first and second guide bars 310 and 320.

End portions of the first to third robot arms 330, 340, and 350 may move with a preset degree of freedom, but may move the preset degree of freedom of ‘6’. A separate driving motor (not illustrated) may be provided at each joint J of the first, second and third robot arms 330, 340 and 350, and the end portions of the first, second and third robot arms 330, 340 and 350 and the first, second, and third grippers 330G, 340G, and 350G provided in the first, second and third robot arms 330, 340 and 350 may be moved to desired positions in the final stage according to the operation of each driving motor.

Each of the first, second, and third grippers 330G, 340G, and 350G, which has a pair of fingers which is able to be open or closed may be grip the clothes A or the hanger B. The first and second grippers 330G and 340G may grip an end portion of the clothes A. The third gripper 350G may be configured to grip the hanger B and unfold a foldable hanger B in one-touch type.

Separate driving motors (not illustrated) may be interposed between end portions of the first to third robot arms 330, 340, and 350 and the first to third grippers 330G, 340G, and 350G, and the first to third grippers 330G, 340G, and 350G may be rotated about end portions of the first to third robot arms 330, 340, and 350 depending on the operations of the driving motors.

Driving cylinders (not illustrated) may be provided in fingers of the first gripper 330G, fingers of the second gripper 340G, and fingers of the third gripper 350G. The fingers of the first to third grippers 330G, 340G, and 350G may be open or closed depending on the operation of each driving cylinder to jig cloths or a hanger.

An image sensor 370 may be a vision camera which may be positioned at upper portions or lower portions of the first and second guide bars 310 and 320 to photograph the shape of the clothes A jigged by the first and second grippers 330G and 340G at the same height.

The clothes have to be spread before folded. The image sensor 370 may photograph only the whole shape of the clothes A or the lower shape of the clothes A to determine the spread state of the clothes A. The image of the photographed clothes A may be transmitted to a controller 380.

The controller 380 may control the operations of the first to third robot arms 330, 340, and 350 and the first, second, and third grippers 330G, 340G, and 350G.

The controller 380 may store reference images for determining the spreading state of clothes A according to the types of clothes A, may compare the lowest images of the clothes A received from the image sensor 370 with the reference images, and may determine the spreading sate of the clothes A.

The controller 380 may repeatedly control the first and second robot arms 330 and 340 and the first and second grippers 330G and 340G, thereby repeatedly performing a series of process that the lowest part of the clothes A is picked up and the clothes A is lifted, alternately at opposite sides until the clothes A is completely spread.

When one of the first and second grippers 330G and 340G lifts the clothes A in the air, the clothes A is hung on one gripper. The lowest part of the above-described clothes A may be regarded as a part away downward from the gripper, and the highest part of the clothes A may be regarded as a part jigged by the gripper.

Preferably, the controller 380 may completely spread the clothes A by repeatedly performing the series of processes of picking up and lifting the clothes at least five times.

Thereafter, the controller 380 may perform a process of hanging the clothes A, which is jigged by the first and second grippers 330G and 340G, on the hanger B by controlling the operations of the third robot arm 350 and the third gripper 350G, and further, provide the hanger B having the clothes A to a folding unit (not illustrated) to fold the clothes A.

As described above, according to the firs embodiments, the third robot arm 350 may be positioned lower than one of the first and second robot arms 330 and 340.

Accordingly, when the hanger B jigged by the third robot arm 350 and the third gripper 350G is introduced into the lowest part, that is, a body part of the clothes A jigged by the first and second grippers 330G and 340G, the clothes A may be hung on the hanger B.

In the robot 300 according to a second embodiment of the present disclosure, the third robot arm 350 is positioned higher than one of the first and second robot arms 330 and 340, and a hanger A unfolded in one touch type may be used.

Accordingly, when the hanger A in one touch type, which is jigged by the third robot arm 350 and the third gripper 350G, is introduced into the highest part, that is, the head part of the clothes A jigged by the first and second grippers 330G and 340G, and the third gripper 350G touches the hanger B in one touch type, the hanger B is unfolded and the clothes A may be hung on the hanger B.

According to the third embodiment of the present disclosure, the robot 300 may further include a fourth robot arm 360 and a fourth gripper 360G to transfer the hanger B having the clothes A, which is spread, to a folding unit (not illustrated) which is positioned outside the first and second guide bars 310 and 320.

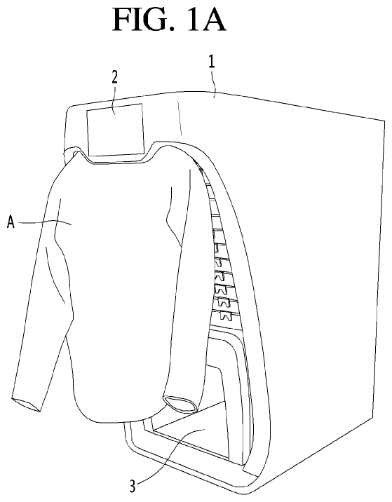

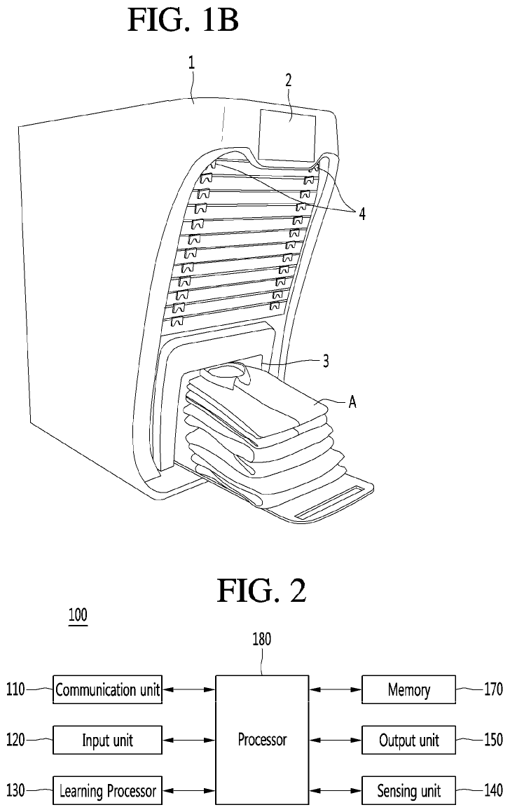

Accordingly, when the clothes A, which is spread, is hung on the hanger A jigged by the third robot arm 350 and the third gripper 350G, the fourth robot arm 360 and the fourth gripper 360G may transfer the hanger B having the clothes A jigged by the third robot arm 350 and the third gripper 350G to the outer folding unit 1 (illustrated in FIGS. 1A and 1B).

The robot 300 having the above-described structure picks up one pieces of clothes A of a mass of clothes tangled with each other, spreads the clothes, hangs the clothes A on a hanger B through a series of processes, and provided the clothes A, which is continuously spread, to the folding unit 1 (see FIGS. 1A and 1B). Then, the folding unit 1 (see FIGS. 1A and 1B) may fold the clothes in the predetermined shape.

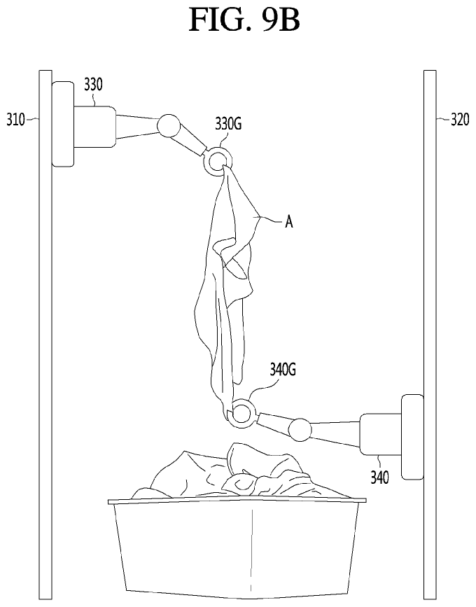

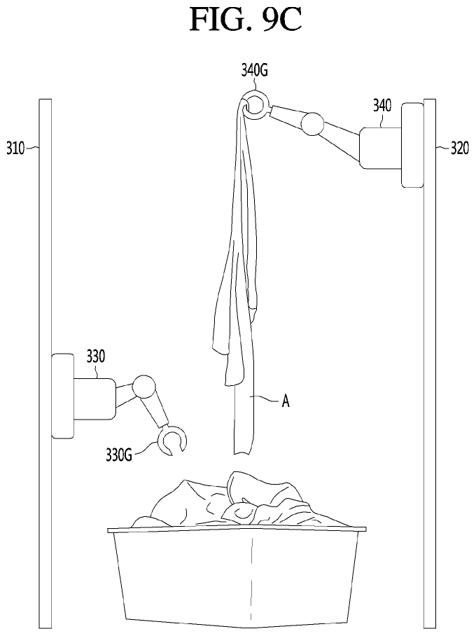

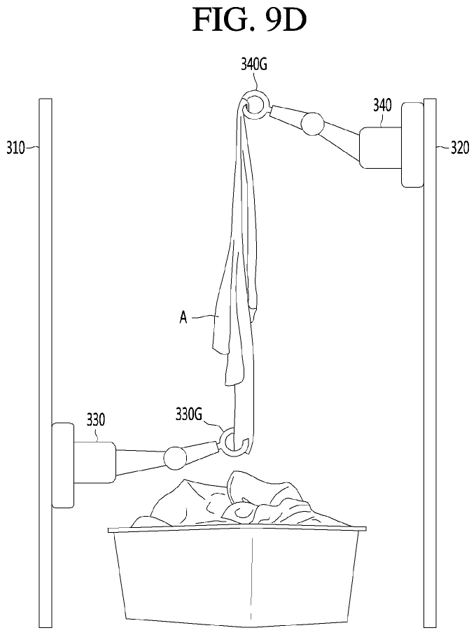

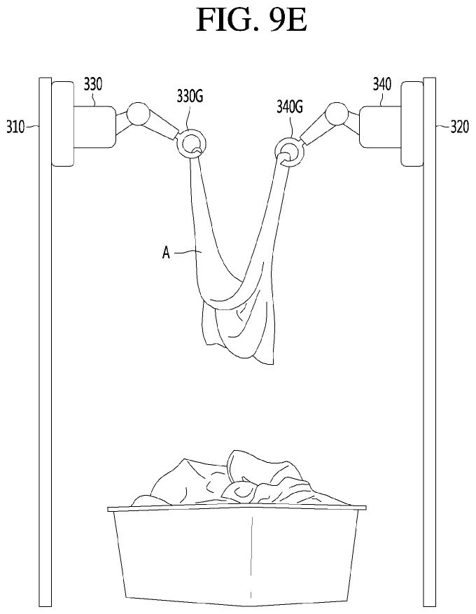

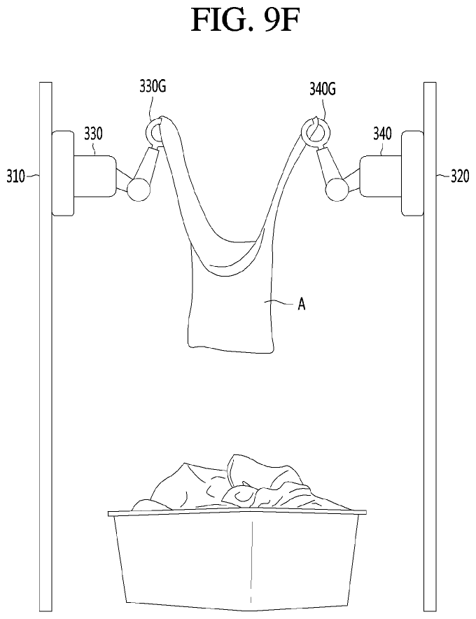

FIGS. 9A to 9F are views illustrating a process that the robot spreads clothes according to the present disclosure.

Regarding the process that the robot spreads the clothes according to the present disclosure, as illustrated in FIG. 9A, the first robot arm 330 is moved down, the first gripper 330G jigs one clothes A of a plurality of clothes, and the first robot arm 330 is moved up to lift clothes jigged by the first gripper 330G.

Thereafter, as illustrated in FIG. 9B, the second robot arm 340 is moved down, the second gripper 340G jigs the lowest part of the clothes A jigged by the first griper 330G, and then the second robot arm 340 is moved up to lift the clothes A jigged by the second gripper 340G as illustrated in FIG. 9C.

Thereafter, as illustrated in FIG. 9D, in the state that the first gripper 330G releases the clothes A, the first robot arm 330 is moved down, the first gripper 330G jigs the lowest part of the clothes A jigged by the second gripper 340G, and the first robot arm 330 is moved up to lift the clothes A jigged by the first gripper 330G as illustrated in FIG. 9E.

Thereafter, as illustrated in FIG. 9F, if the first and second grippers 330G and 340G lift opposite sides of the clothes A, the above-described image sensor 370 (see FIG. 8) photographs the lowest part of the clothes A, and the controller 380 (see FIG. 8) receives thee photographed image to determine whether the clothes A is spread.

The first and second robot arms 330 and 340 are moved such that the end portions of the first and second robot arms 330 and 340 are spread from each other, and the image sensor 370 (see FIG. 8) photographs the lowest part of the clothes A in the state that the clothes A jigged by the first and second grippers 330G and 340G are pulled on both sides. In this case, whether the clothes A is spread may be more exactly determined.

If it is not determined that the lowest part of the clothes A is spread, the first and second robot arms 330 and 340 and the first and second grippers 330G and 340G may alternately repeat a series of processes of lifting the lowest part of the clothes A at opposite sides.

When the above processes are repeated at least five times, it may be determined that the lowest part of the clothes A is spread.

If it is determined that the lowest part of the clothes A is spread, the third robot arm 350 and the third gripper 350G provide the hanger, hang the clothes A jigged by the first and second grippers 330G and 340G on the hanger, and provide the clothes A hung on the hanger to the external folding unit 1 (illustrated in FIGS. 1A and 1B).

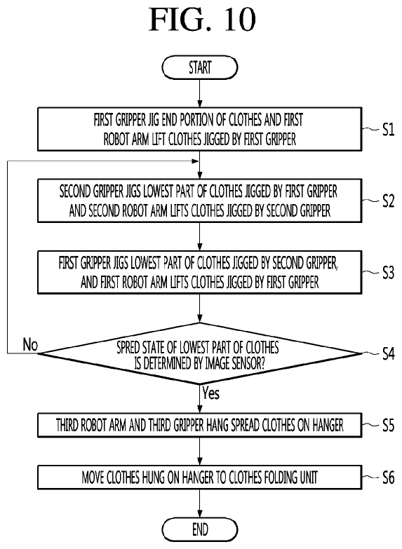

FIG. 10 is a flowchart illustrating the operation of the robot according to the present disclosure.

Regarding the operation of the robot according to the present disclosure, as illustrated in FIG. 10, the first gripper jigs an end portion of clothes, and the first robot arm may lift the clothes jigged by the first gripper (see S1).

When the first robot arm and the first gripper lift one of a plurality of pieces of clothes, the second robot arm and the second gripper may move down the clothes jigged by the second gripper.

Next, the second gripper may jig the lowest part of the clothes jigged by the first gripper and the second robot arm may lift the clothes jigged by the second gripper (see S2).

When the second robot arm and the second gripper lift the lowest part of the clothes to the position of the first gripper, the first robot arm and the first gripper may move down the clothes jigged by the first gripper.

Next, the first gripper jigs the lowest part of the clothes jigged by the second gripper, and the first robot arm may lift the clothes jigged by the first gripper (see S3).

When the first robot arm lifts the lowest part of clothes jigged by the first gripper to the position of the second gripper in the air, the lower spread state of clothes may be determined by the image sensor while the first and second grippers jig opposite sides of the clothes (see S4).

When it is not determined that the lowest part of the clothes is spread, the first and second grippers alternately repeat a process of lifting the lowest part of the clothes.

When it is determined that the lowest part of the clothes is spread, the third robot arm and the third gripper hang clothes jigged by the first and second grippers on the hanger and then may move the clothes hung on the hanger to the clothes folding unit (see S5 and S6).

While the present disclosure has been described with reference to exemplary embodiments, it will be apparent to those skilled in the art that various changes and modifications may be made without departing from the spirit and scope of the present disclosure.

Therefore, the exemplary embodiments of the present disclosure are provided to explain the spirit and scope of the present disclosure, but not to limit them, so that the spirit and scope of the present disclosure is not limited by the embodiments.

The scope of the present disclosure should be construed on the basis of the accompanying claims, and all the technical ideas within the scope equivalent to the claims should be included in the scope of the present disclosure.

1. A robot comprising:
a first guide bar and a second guide bar separated from each other;
a first robot arm and a second robot arm provided to be lifted or rotated along the first and second guide bars and having end portions to move with a predetermined degree of freedom;
a first gripper and a second gripper provided end portions of the first and second robot arms to grip clothes;
an image sensor to measure a shape of the clothes jigged by the first and second grippers; and
a controller to control operations of the first and second robot arms and the first and second grippers depending on the shape of the cloths measured by the image sensor.

2. The robot of claim 1, wherein the first and second robot arms are provided on opposite surfaces of the first and second guide bars.

3. The robot of claim 1, wherein the image sensor photographs the shape of the clothes when the first and second robot arms and the first and second grippers jig and lift the clothes.

4. The robot of claim 1, wherein the controller is configured to determine an unfolding state of the clothes by comparing a lower image of the clothes, which is measured by the image sensor, with reference images which are previously input.

5. The robot of claim 1, wherein the controller is configured to control a process of allowing the second robot arm and the second gripper to jig a second point of the clothes, which is lower than a first point of the clothes, and to lift the clothes, when the first robot arm and the first gripper jig the first point of the clothes and lift the clothes in the air and allowing the first robot and the first gripper to jig a third point of the clothes, which is lower than the second point of the clothes, and to lift the third point of the clothes in the air.

6. The robot of claim 5, wherein the controller is configured to set the lowest part of the clothes to the second point or the third point when lifting the clothes in the air.

7. The robot of claim 5, wherein the controller is configured to repeatedly control the process until determining that the shape of the clothes measured by the image sensor is unfolded.

8. The robot of claim 6, wherein the controller is configured to perform the process at least five times.

9. The robot of claim 1, further comprising:
a third robot arm provided on one of the first and second guide bars to be lifted or rotated and having an end portion to move with a predetermined degree of freedom; and
a third gripper provided at the end portion of the third robot arm to jig a hanger for hanging the clothes,
wherein the controller is configured to
control operations of the third robot arm and the third gripper depending on the shape of the clothes, which are measured by the image sensor.

10. The robot of claim 9, wherein the third robot arm is provided under one of the first and second robot arms.

11. The robot of claim 9, wherein the third gripper is able to jig the hanger unfolded in one-touch type.

12. The robot of claim 9, wherein the controller is configured to control the third robot arm and the third gripper to hang the clothes, which are jigged by the first and second grippers, on the hanger, when the shape of the clothes measured by the image sensor is determined as being unfolded.

13. The robot of claim 9, wherein the controller is configured to control the third robot arm and the third gripper to move the hanger and clothes hung on the hanger to move a specific position out of the first and second guide bars.

14. The robot of claim 9, further comprising:
a third robot arm provided on one of the first and second guide bars to be lifted or rotated and having an end portion to move with a predetermined degree of freedom; and
a fourth gripper provided at the end portion of the fourth robot arm to jig a hanger jigged by the third gripper,
wherein the controller is configured to control the forth robot arm and the fourth gripper to move the hanger and clothes hung on the hanger to move a specific position out of the first and second guide bars.

15. A clothes folding apparatus comprising:
the robot according to claim 1; and
a folding unit to receive unfolded clothes from the robot and to fold the clothes in a predetermined shape.
